(19) United States
(12) Patent Application Publication
(10) Pub. No.: US 2007/0005464 A1
(43) Pub. Date: Jan. 4, 2007

(54) Systems, methods, and computer-readable media for providing a billing statement including incentives for mailing timely payments

(75) Inventors: Charles Rosenblatt, Richmond, VA (US); Jenifer Meehan, Glen Allen, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/168,916

(22) Filed: Jun. 29, 2005

(51) Int. Cl. G06Q 40/00

(52) U.S. Cl. 705/35

(57) ABSTRACT

Systems, methods, and computer-readable media provide mechanisms to manage a financial account of a cardholder by defining one or more attributes associated with the financial account. The one or more attributes comprising information on one or more incentives for a billing statement for the financial account. A cardholder or other individual associated with the financial account may then be sent the billing statement, wherein the billing statement includes one or more incentives, such as incentives for one or more children of the cardholder or other individuals related to the cardholder (such as a spouse, a grandparent, etc.). The incentives may be conditioned on and used for encouraging timely payment by the cardholder.

### TECHNICAL FIELD

The present invention relates generally to financial accounts and, more particularly, to the management of financial accounts having a billing statement that includes an incentive, such as an incentive for making a timely payment or incentives for a cardholder's children.

### BACKGROUND

Credit card products have become so universally well known and ubiquitous that they have fundamentally changed the manner in which financial transactions and dealings are viewed and conducted in society today. Credit card products are most commonly represented by plastic card-like members that are offered and provided to consumers through credit card issuers (such as banks and other financial institutions). With a credit card, an authorized consumer is capable of purchasing services and/or merchandise without an immediate, direct exchange of cash. Instead, the customer incurs debt with each purchase. Thereafter, the customer repays the debt upon receipt of a periodic statement from the issuer. When using the credit card to make a purchase, the transaction is processed via a credit card clearinghouse or authorization system, such as the Visa or MasterCard networks.

In addition to credit cards, there are other financial account cards that function like credit cards, but that are associated with a bank account, like a checking account. Such cards are sometimes called check cards. Like credit card purchases, transactions made by using check cards are cleared through a credit card clearinghouse. Debit cards are another type of financial account cards. Debit cards are also ordinarily associated with a bank account of some type. A common type of debit card is the automated teller machine (“ATM”) type card. There are also other types of payment cards, such as stored value cards; smart cards; secured cards, where a customer may pay a security deposit before being given the ability to leverage the credit product; and prepaid credit products, where a credit balance is created via prepayment and then utilized at point-of-sale locations.

Credit card issuers and other payment system operators collect a large amount of customer data, some of which is obtained from customers directly. To apply for a credit card, for example, an applicant typically must supply demographic data (e.g., age or city of residence), financial data (e.g., monthly expenses, income, or bank account balance), and employment data (e.g., salary or length of employment). To determine whether to issue a card to the applicant, an issuer may also contact a credit reporting agency to obtain the applicant's credit history.

After issuing a credit card product to a cardholder, a credit card company may send a billing statement to the cardholder explaining the monthly charges to the account. The cardholder is given a certain number of days to send a payment to pay the balance of the credit card. Often times, however, credit card companies may have customers who are delinquent on paying their credit card balances.

Conventional means to send billing statements are in the form of a paper-based statement through the mail. Often times these billing statements become one of many bills or other mailings received by a cardholder and, as a result, the billing statements are forgotten or disregarded. In many cases, the cardholder may forget the due date of a billing statement or make a late payment because the statement is with a stack of other mailings sent to the cardholder. Therefore, there is a need to draw attention to the billing statement to encourage cardholders to recognize due dates and send in timely payments. It is known to includes incentives with billing statement mailings. Such incentives may include coupons, rebates or other offers. Despite these incentives, the billing statement mailings are still overlooked or ignored. In some cases, the incentives are unattractive or limited to incentives associated with the cardholder or cardholder's account. As a result, such incentives do not overcome the problems with billing statement mailings.

Accordingly, there is a need for improved systems, methods, and computer-readable media for providing and managing financial accounts that draw attention to the billing statements by including incentives for individuals related to the cardholder, in order to reward the cardholder for sending payments on time.

### SUMMARY

Systems, methods, and computer-readable media consistent with the present invention address these and other needs by providing mechanisms to manage a financial account, including sending a billing statement to the customer at the end of each billing period that includes an incentive, such as an incentive for the cardholder's children.

Systems, methods, and computer-readable media consistent with the present invention may defining one or more attributes associated with a financial account. The one or more attributes may comprise information on one or more incentives for a billing statement for the financial account. The cardholder associated with the financial account may then be sent the billing statement, wherein the billing statement includes one or more incentives for one or more children related to the cardholder depending on the one or more attributes of the financial account. The financial account may be a credit card account.

In another embodiment, a method for managing a financial account of a cardholder is provided. The method may comprise defining one or more attributes associated with the financial account, the one or more attributes comprising information on incentives for a billing statement for the financial account. The method may also monitor the financial account to identify a late payment by the cardholder on the financial account, and send the cardholder the billing statement, wherein the billing statement includes incentives depending on whether a late payment is identified, and further wherein the incentives included with the billing statement comprise incentives for at least one individual related to the cardholder.

In another embodiment, a system for managing a financial account of a cardholder is provided. The system may comprise a component for defining one or more attributes associated with the financial account, the one or more attributes comprising information on one or more incentives for a billing statement for the financial account. The system may also comprise of a component for sending the cardholder the billing statement, wherein the billing statement includes one or more incentives for one or more children related to the cardholder depending on the one or more attributes of the financial account.

In another embodiment consistent with the present invention, a computer-readable medium which stores a set of instructions which when executed performs a method for managing a financial account of a cardholder is provided. The method may comprise defining one or more attributes associated with the financial account, the one or more attributes comprising information on one or more incentives for a billing statement for the financial account. The method may further comprise sending the cardholder the billing statement, wherein the billing statement includes one or more incentives for one or more children related to the cardholder depending on the one or more attributes of the financial account.

It is to be understood that both the foregoing general summary and the following detailed description are exemplary and explanatory only, and are not restrictive of the invention, as claimed. Further features and/or variations may be provided in addition to those set forth herein. For example, the present invention may be directed to various combinations and subcombinations of the disclosed features, and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments of the present invention and, together with the description, serve to explain the principles of the invention. In the drawings:

FIG. 1 is a schematic illustration of an exemplary system environment 100, consistent with the present invention;

FIG. 2 is a flow chart of an exemplary method for providing and managing financial accounts, consistent with the present invention; and

FIG. 3 is a flow chart of an exemplary method for offering an account to a potential customer, consistent with the present invention.

### DETAILED DESCRIPTION

Systems, methods, and computer-readable media consistent with the present invention may provide a customer with incentives for individuals related to the customer, such as a customer's children and/or spouse, along with the billing statement of a financial account, if the balance for the financial account is paid on time. Consequently, systems, methods, and computer-readable media consistent with the present invention provide unforeseen benefits by providing incentives for individuals related to the customer of a financial account and draw attention to the billing statement, therefore encouraging the customer to make timely payments on the financial account. Systems, methods, and computer-readable media consistent with the present invention provide a mechanism to make sure payments on financial accounts are received on time.

For simplicity, exemplary financial accounts of the present invention are described as a single credit card account. However, those of skill in the art will recognize that the present invention may also be used with checking accounts (check cards), debit accounts (debit cards) and other types of cards offered by financial account institutions, credit card companies and banks.

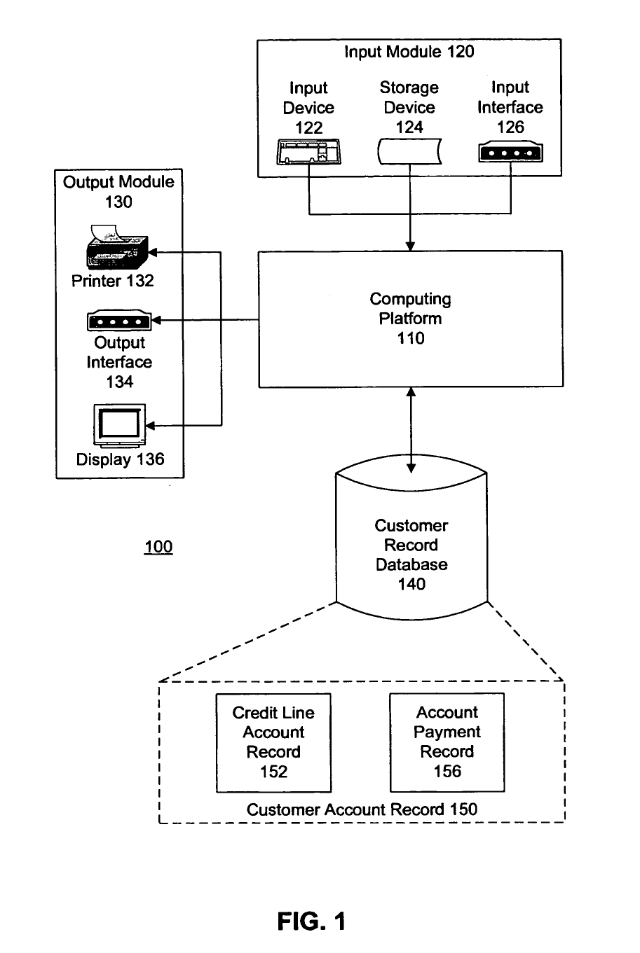

FIG. 1 illustrates an exemplary system environment 100, consistent with the present invention. As illustrated in FIG. 1, issuer system 100 includes a computing platform 110, an input module 120, an output module 130, and a customer record database 140.

Computing platform 110 is adapted to process input information received from input module 120. Computing platform 110 is further adapted to provide output information to output module 130. Additionally, computing platform 110 is adapted to access information in customer record database 140 for use in performing methods consistent with the present invention (discussed below).

Computing platform 110 preferably comprises a general purpose computer (e.g., a personal computer, network computer, server, or mainframe computer) having a processor that may be selectively activated or reconfigured by a computer program to perform one or more methods consistent with the present invention. Computing platform 110 may also be implemented in a distributed network. Alternatively, computing platform 110 may be specially constructed for carrying out methods consistent with the present invention.

Input module 120 may include an input device 122, a storage device 124, and/or an input interface 126. Input device 122 may be implemented using a keyboard, mouse, speech recognition device, or other user interface adapted for data entry. Storage device 124 may include a memory, such as RAM or ROM memory that contains instructions or data for performing one or more methods consistent with the present invention. Computing platform 110 may link storage device 124 to input interface 126. Input interface 126 may in turn be linked to a device (not shown), such as a disk drive or the Internet, for transferring instructions from a computer-readable medium to the storage device 124 for later execution by the computing platform 110.

Consistent with the present invention, a computer-readable medium is any type of medium that is capable of carrying information that may be used to configure computing platform 110 to perform methods consistent with the present invention. The computer-readable medium may be, for example, a physical medium (e.g., a punch card), a magnetic medium (e.g., a magnetic disk or tape), an optical medium (e.g., an optical disk), or a carrier wave (e.g., from a computer network, such as the Internet). The computer-readable medium may be encoded with instructions for configuring the computing platform to perform one or more methods consistent with the present invention. The computer-readable medium may also contain data used in such methods.

In creating a new account, input module 120 may be used to enter or obtain information about a customer and/or attributes of the customer's accounts. This information may be obtained, for example, from the customer, from storage device 124, or from a computer-readable medium, such as a disk drive or carrier wave, via input interface 126. After a new account has been created, input module 120 may be used to enter or obtain information about transactions made by the customer using the account. Computing platform 110 may then store the information received for input module 120 in customer record database 140.

As described below, computing platform 110 uses the stored account information to manage the customer's account using methods consistent with the present invention. Computing platform 110 also provides account information generated by computing platform 110 or obtained from customer record database 140 to output module 130. Output module 130 in turn outputs the received information to the customer or to customer service representatives for use internally or for assisting the customer.

Output module 130 may include a printer 132, an output interface 134, and/or a display 136. Printer 132 may be used to provide a conventional billing statement to the customer. Output interface 134 may provide billing and other information to the customer via the Internet in the form of an online account statement, or save the information on a computer-readable medium. Display 136 may provide account information to customer service representatives who may assist the customer via telephone.

Customer record database 140 may be used to store customer account records 150. Customer account records 150 preferably include the customer's identifying information, such as the customer's name, billing address, telephone number, and/or Social Security number, etc. Customer account records 150 may also include other information about the customer, such as the customer's credit rating, credit history, demographic information, the customer's marital status, information on the customer's children, and/or information on the customer's spouse. Information on a customer's children may include the age and sex of each child, as well as personal interests of each child, each child's grade in school, as well as any other relevant information about each child. Information on the customer's spouse may include the age of the spouse, as well as personal interests of the spouse.

Customer account records 150 preferably also include a credit line account record 152 and an account payment record 156. The information contained in these records corresponds to information contained in an account agreement between the customer and the issuer that governs the terms of the account. These records also contain information corresponding to transactions made by the customer using the account. The information to be entered in records 150,152, and 156 may be entered or obtained using input module 120.

Credit line account record 152 may store information related to the attributes of the credit line account, such as: the credit limit; the grace period on purchases; minimum credit line purchase requirements; the interest rate on the credit line account; the minimum payment on the credit line account; conditions for modification of the credit line account attributes; and/or information on rewards, e.g., cash back, used to encourage purchases using the credit line account.

Credit line account record 152 may also store information regarding credit line account transactions of a customer. Transaction information may include information for each transaction such as the date of a purchase, the merchant name, the merchant city and merchant state, the merchant type, as well as the types of merchandise purchased at the merchant. Credit card account record 152 may also include information about the current credit line balance, and the amount of credit currently available to the customer.

Account payment record 156 stores information concerning payments made to the issuer by the customer. This information may include information indicating the date a payment was made on the account. Account payment record 156 may also include information indicating the number of times a payment has been late on the account. Account payment record 156 may also include a summary of each payment on the account. For example, account payment record 156 may include information indicating, for each month, the date the payment was due and the actual date the payment was received.

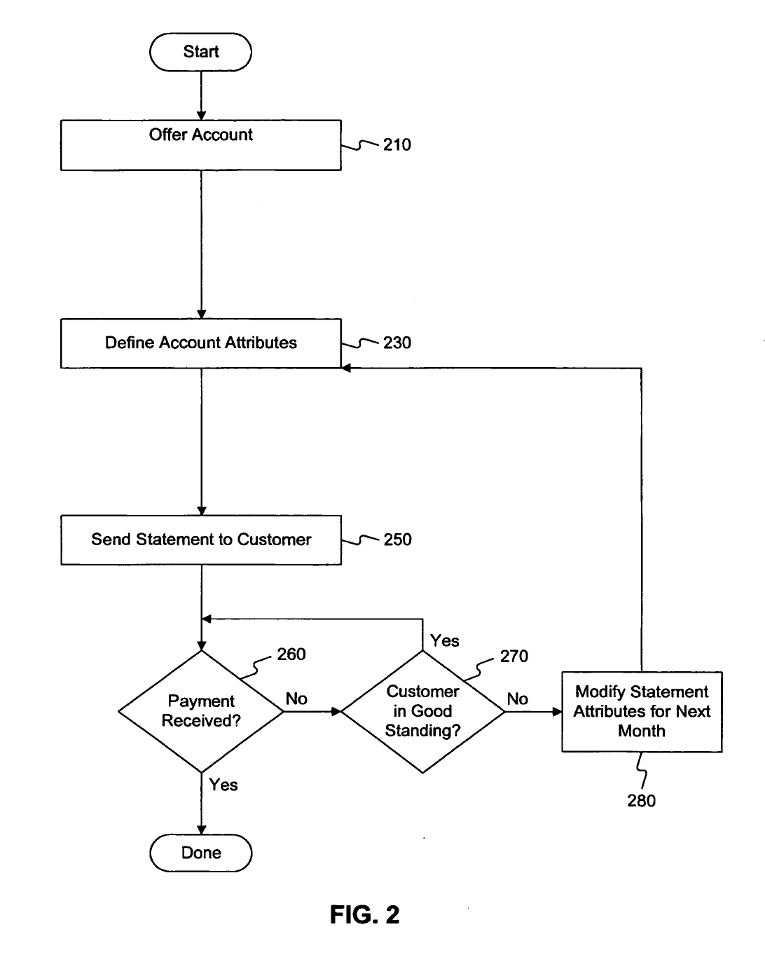

FIG. 2 illustrates an exemplary method for providing and managing financial accounts, consistent with the present invention. While exemplary methods of the present invention are described as a series of acts, the order of the acts may vary in other implementations consistent with the present invention. In particular, non-dependent acts may be performed in any order or in parallel.

An issuer system 100 may first offer an account with attributes consistent with the present invention to a potential customer (stage 210). Offering the account may involve identifying a customer (either new or existing), customizing or changing the terms and conditions of the account (depending on whether the account is a new account or an existing account) for the customer, and communicating the attributes of the account to the customer.

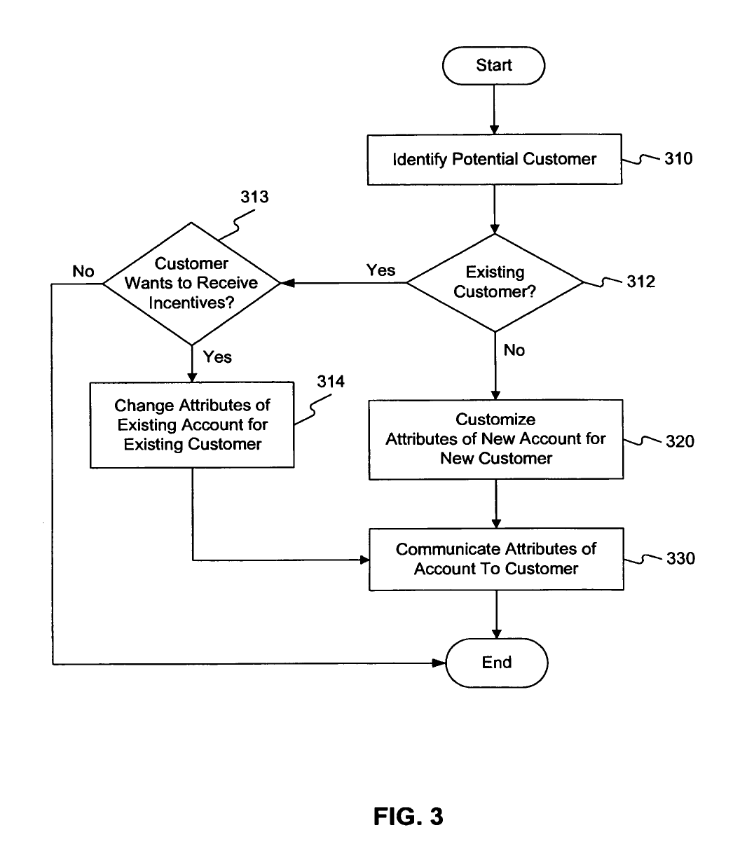

By way of example, FIG. 3 is a flow chart of a method for offering an account to a customer (stage 210), consistent with the present invention. Identifying a customer (stage 310) may be done in a number of ways. A potential customer may be identified based on customer characteristic believed to indicate that the customer would be sufficiently likely to respond to an offer of an account consistent with the present invention. For example, a customer who is identified as having one or more children may be sufficiently likely to respond. Furthermore, a customer who may have grandchildren may also be sufficiently likely to respond. A customer that may be married and has a spouse may also be sufficiently likely to respond. Alternatively, the customer may identify themselves by contacting the issuer, e.g., in response to an earlier offer or advertisement.

After a potential customer is identified, issuer system 100 may then determine whether the customer is an existing customer with the issuer (stage 312). If the customer identified in stage 310 is an existing customer, issuer system 100 may search customer record database 140 to locate the customer's financial account, and present the existing customer with an offer for an additional feature on the existing account to receive incentives for individuals related to the customer along with the billing statement already received by the cardholder (stage 313). For example, issuer system 100 may send an existing customer an offer to receive incentives for individuals related to the customer on a billing statement, and the customer may indicate whether to receive these incentives on the billing statement portion sent with payment back to the issuer. If the customer accepts the offer, issuer system 100 may then change the terms and conditions of the existing account for the existing customer (stage 314) as described below.

If in stage 312 issuer system 100 determines that the customer is a new customer, the terms and conditions of the offered account may be initially customized for the potential customer (stage 320). The terms and conditions of the offered account may be customized for the particular customer both before and/or after the initial offer is communicated to the customer, and presented to the customer in a customized offer.

The terms and attributes of an existing account for an existing customer and a new account for a new customer may include creating an account or modifying an account where the customer receives various incentives for the customer's children and/or spouse, along with the billing statement sent to the customer at the end of each billing cycle. The incentives may be mailed with the billing statement associated with the account. While the specifics of the incentives may not be communicated to a new customer before the customer accepts the offer, or to an existing customer before the existing customer accepts the additional feature option of receiving incentives, both the existing and new customer may be sent general conditions for the account.

The terms and conditions of the new or existing account may inform the customer of an offer to receive various incentives along with the billing statement received each month. The incentives may be at no charge to the customer and may be in various formats and may be associated with various subject matter. The terms and conditions may also inform the customer that the customer may select the format and subject matter of each incentive. The terms and conditions may also inform the customer that the incentives may be related to purchasing behavior of the customer, as further explained below.

Incentives may also be in the form of stickers, gifts, prizes, such as a press-on tattoo. The stickers may or may not have coupons on the back of each sticker for the parents. The coupons may be related to various services the parents may use. For example, a sticker for a child may have the back label as a coupon to a grocery store or a gas station for the parents.

Consistent with the invention, the incentives may also be associated with different subject matter. The subject matter of the incentives may be determined in a variety of ways, as further described below.

As will be appreciated by those skilled in the art, the incentives are not limited to the ones listed above and may be in other forms, shapes, and sizes consistent with the present invention.

The terms and conditions may also include provisions for receiving the incentive. The customer may be informed that in order for the billing statement to include an incentive each month, the customer may not be late in making a payment on a previous month's payment. The various provisions are discussed further below.

Once the terms and conditions of the account are initially customized, the offer may then be communicated to the customer (stage 330) in a number of ways, e.g., via electronic mail, regular mail, an Internet Web page, telephone, or media advertisement. For example, an issuer may contact an existing customer via phone to inquire whether the customer would like to receive an incentive with each billing statement for the customer's child. Once the existing customer accepts the offer, the new terms may be memorialized in the existing account agreement. In another example, an issuer may contact a potential customer via electronic mail to inquire whether the customer would like to open an account where the customer receives an incentive with each billing statement for the customer's spouse. Once the new customer accepts the offer, a new account may be opened and the terms may be memorialized in an account agreement that will govern the attributes of the account.

Referring again to FIG. 2, once a new customer accepts the offer for a new account or an existing customer accepts an offer to receive incentives with the existing billing statement, the account attributes may be defined (stage 230). Issuer system 100 may be used to define or otherwise customize the attributes of the account for a particular customer. Input module 120 may be used to gather identifying information about a particular customer, as well as information concerning the particular customer's credit history and the particular customer's children, spouse, and/or relatives, etc. This information may be available from the customer or from another source, such as a financial database or one of the customer's existing creditors.

Computing platform 110 may use the customer's identifying information to determine various incentives to send with each billing statement. This information may be entered in customer account records 150. In one embodiment, a customer may be asked more questions regarding the customer's children. For example, a customer may be asked the age of their children, the sex of their children, and any specific interests pertaining to each child. The customer may also be asked what grade each child is in at school. In another embodiment, the customer may also be asked questions regarding the customer's spouse, such as any personal interests of the spouse.

In an exemplary embodiment consistent with the invention, defining the account attributes at stage 230 includes determining the format and subject matter of incentive that is sent along with each billing statement, as well as the quantity of the incentive sent with each billing statement.

Computing platform 110 may use the customer's previous customer information and any new information gathered to customize the format and subject matter of the incentive included with the billing statement mailed to the customer at the end of the account billing cycle. For example, a customer that has a seven-year-old son for a child may receive stickers of trucks every month with their billing statement. A customer with a thirteen-year-old daughter may receive a press-on tattoo of a rabbit.

Issuer system 100 may allow the customer to choose the format and subject matter of the incentive including with the billing statement. Issuer system may allow the customer to indicate on a billing statement the format and subject matter of incentive to review. Issuer system 100 may allow the customer to fill out a designated area on the billing statement the various format and subject matter incentives the customer would like to receive. In another example, a customer may receive a billing statement initially and may indicate on the billing statement to receive stickers of cartoons animals or press-on tattoos of trucks with the next billing statement. Issuer system 100 may allow a customer to change the format and subject matter of the with each billing statement.

Issuer system 100 may also use the purchasing behavior of the customer to determine the format and the subject matter of the incentive included with the billing statement. Issuer system 100 may use the information regarding the credit line account transactions of a customer stored in credit line account record 152 to determine the format and subject matter of the incentive. For example, Issuer system 100 may send a customer with transactions at Disney World stickers of Disney World characters. In another example, Issuer system 100 may include miniature versions of cartoon characters for customers with purchase transactions related to the same cartoon characters.

A billing statement may then be sent to the customer at the end of a billing cycle (stage 250). A billing cycle may occur monthly, as is conventional, but may also occur as determined by the issuer system 100. The billing statement may include a conventional paper-based statement, mailed to the customer before the due date of the payment. Alternatively, the statement may be Internet-based, e.g., made available on a Web site or sent to the customer via e-mail.

The statement may include information such as the due date of the payment, the total minimum payment due, the minimum payment for each of the credit line and balance transfer accounts, information (e.g., vendor, amount, date of purchase, and/or time of purchase) for the transactions made against the credit line of the account, the total amount of available credit, and other information that may assist the customer.

In an exemplary embodiment of the invention, if the billing statement is electronic or Internet-based, either available online or sent to the customer via e-mail, the customer may still receive the incentive in a separate mailing or may receive an electronic coupon. The same provisions and conditions of the paper-based billing statement described above also apply to the Internet-based billing statement.

In another exemplary embodiment of the invention, the billing statement may include more than one incentive for the customer's children and/or spouse. For example, if a customer indicated in stage 230 that the customer has more than one child, issuer system 100 may then determine in stage 230 to send the same number of incentives as the number of children of the customer.

In yet another embodiment, the billing statement may include more than one incentive for each child and/or more than one incentive for the spouse. For example, if a customer has one child, issuer system 100 may then determine in stage 230 to send more than one incentive for the customer's child. In another example, if the customer is married, issuer system 100 may then determine in stage 230 to send more than one incentive for the spouse.

The determination of whether to send more than one incentive with the billing statement may depend on a variety of factors. One factor may be whether the customer is in good standing. For example, if a customer has been in good standing for more than one year, issuer system 100 may determine to send the customer more than one incentive per child. Other factors issuer system 100 may rely on to send more than one incentive per child include customer status (active or inactive). A customer may have an active status if the customer has used the credit card within the past 45 days or the customer has a balance remaining on the credit card.

After providing the customer with a billing statement, issuer system 100 awaits receipt of payment from the customer (stage 260). Once issuer system 100 determines that payment has been received, computing platform 110 applies the payment toward the interest and/or fees (e.g., penalty fees or finance charges) due on the account (if any). Computing platform 110 then accesses account payment record 156 to determine if the payment was received on time.

If the payment was not received on time, issuer system 100 may determine whether the customer is in good standing with the issuer (stage 270). The determination of whether a customer is in good standing may depend on a variety of factors, as described above. Issuer system 100 may determine whether a customer is in good standing by determining whether they have missed a certain number of payments within a calendar year. Issuer system 100 may also determine whether a customer is in good standing by determining whether a customer has been delinquent on a certain number of payments within a calendar year. Another factor that issuer system 100 may depend on to determine whether a customer is in good standing is payment history. A customer may be in good standing if the customer has made a payment on the account within the past 30 days. One skilled in the art will appreciate that other factors may be used by an issuer to determine whether a customer is in good standing, and that embodiments of the present invention are not limited to those listed above.

In an exemplary embodiment of the invention, if the customer is in good standing, issuer system 100 may then await payment from the customer past the due date of the payment. If the payment is received late, issuer system 100 may determine not to change any account attributes relating to billing statement of the customer's account. Therefore, even if a payment is late, issuer system 100 may send the customer the incentive along with the billing statement in the following month.

In another exemplary embodiment, even if a customer is in good standing, issuer system 100 may change the account attributes to modify the billing statement so that an incentive is not included in the next month's billing statement. This may be for one billing period or may be for a number of billing periods, as determined by issuer system 100.

The conditions for modification of the account attributes may also allow issuer system 100 to modify one or more of the account attributes if the customer is not in good standing with the issuer (stage 280). For instance, issuer system 100 may modify the billing statement so that no incentive is sent with the billing statement the month after a missed payment. Issuer system 100 may also send a reminder letter to the customer informing the customer of the late payment and making the customer aware of the various conditions associated with receiving the statement.

In another embodiment, the conditions for modification of the account attributes may allow issuer system 100 to modify one or more of the account attributes related to the billing statement only if the customer requests or otherwise consents. For instance, issuer system 100 may allow the customer to choose the format of the incentives received with each billing statement. For example, a customer may decide to only receive stickers with each billing statement. Issuer system 100 may also allow the customer to choose what not to receive with each billing statement, as opposed to selecting what to receive. For example, a customer may wish to never receive press-on tattoos.

As will be appreciated by those skilled in the art, the incentives for the children and/or spouse of the customer may be included with any type of account with a billing statement and is not limited to a credit card account or a check card account. For example, the incentives may be included along with a utility, mobile, telephone, cable, water, gas, electric billing statement.

If the issuer system 100 determines that one or more account attributes are to be modified, computing platform 110 returns to stage 230 in order to redefine the attribute(s) in the appropriate account records 150,152, and/or 156. The process then returns to stage 250 where issuer system 100 sends the next billing statement to the customer.

It will be apparent to those skilled in the art that various modifications and variations can be made to the invention without departing from the scope or spirit of the invention.

Other modifications and embodiments of the invention will be apparent to those skilled in the art from consideration of the specification and practice of the invention disclosed herein. Therefore, it is intended that the specification and examples be considered as exemplary only, with a true scope and spirit of the invention being indicated by the following claims.

What is claimed is:

1. A computerized method for managing a financial account of a cardholder, comprising:
defining one or more attributes associated with the financial account, the one or more attributes comprising information on one or more incentives for a billing statement for the financial account;
sending the cardholder the billing statement, wherein the billing statement includes one or more incentives for one or more children related to the cardholder depending on the one or more attributes of the financial account.

2. The method of claim 1, further comprising:
creating the financial account for the cardholder.

3. The method of claim 1, further comprising:
identifying an existing cardholder associated with the financial account;
determining whether the existing cardholder wants to receive one or more incentives with the billing statement.

4. The method of claim 3, wherein the determining whether the existing cardholder wants to receive the billing statement further comprises:
sending the existing cardholder a questionnaire to indicate whether the cardholder wants to receive one or more incentives with the billing statement.

5. The method of claim 1, further comprising:
gathering information about the cardholder, wherein the information comprises information regarding the children, and transaction information; and
determining a format of each incentive based on the gathered information.

6. The method of claim 5, wherein the format is at least one of a sticker, a toy, a press-on tattoo, and a coupon.

7. The method of claim 5, wherein the transaction information comprises the merchant name, merchant type, merchandise category, merchant city, and merchant state of each transaction against the financial account.

8. The method of claim 7, further comprising:
using the transaction information to determine a purchasing behavior of the cardholder, wherein the one more incentives is related to the purchasing behavior.

9. The method of claim 1, further comprising:
informing the cardholder that the one or more incentives will not be included in a next month's billing statement if a payment indicated in the billing statement is received past a payment due date.

10. The method of claim 1, wherein the one or more attributes include information about whether to include the one or more incentives with the billing statement.

11. The method of claim 10, further comprising:
determining whether a payment associated with the financial account has been received; and
changing the one or more attributes based on the determination of whether the payment has been received.

12. The method of claim 10, further comprising:
determining whether the cardholder is in good standing; and
changing the one or more attributes based on the determination of whether the cardholder is in good standing.

13. The method of claim 12, further comprising:
changing the one or more attributes to indicate not to include the one or more incentives for a next month's billing statement based on the determination of whether the cardholder is in good standing.

14. The method of claim 12, wherein the cardholder is in good standing if the cardholder has made at least the minimum payment in the last 30 days.

15. The method of claim 1, wherein the one or more incentives include an incentive for the cardholder to make a timely payment.

16. The method of claim 1, wherein the billing statement is at least one of a paper-based statement and an Internet-based statement.

17. The method of claim 13, further comprising:
sending the one or more incentives separately if the billing statement is Internet-based.

18. The method of claim 1, further comprising:
allowing the cardholder to select a format and a subject matter of the one or more incentives, wherein the format is at least one of a sticker, a toy, a press-on tattoo, and a coupon.

19. The method of claim 1, wherein the financial account is one of a credit card account or a check card account.

20. The method of claim 10, further comprising:
determining whether the cardholder is an active cardholder; and
changing the one or more attributes based on the determination of whether the customer is an active cardholder.

21. The method of claim 20, wherein determining whether the cardholder is an active cardholder further comprises:
determining whether the cardholder has used the financial account in the past 45 days or has a balance currently on the financial account.

22. A computerized method for managing a financial account of a cardholder, comprising:
defining one or more attributes associated with the financial account, the one or more attributes comprising information on incentives for a billing statement for the financial account;
monitoring the financial account to identify a late payment by the cardholder on the financial account; and
sending the cardholder the billing statement, wherein the billing statement includes incentives depending on whether a late payment is identified, and further wherein the incentives included with the billing statement comprise incentives for at least one individual related to the cardholder.

23. The method of claim 22, further comprising:
creating the financial account for the cardholder.

24. The method of claim 22, further comprising:
identifying an existing cardholder associated with the financial account;
determining whether the existing cardholder wants to receive incentives with the billing statement.

25. The method of claim 22, further comprising:
gathering information about the cardholder, wherein the information comprises information regarding the individuals related to the cardholder, and transaction information; and
determining a format of each incentive based on the gathered information.

26. The method of claim 23, wherein the format is at least one of a sticker, a toy, a press-on tattoo, and a coupon.

27. The method of claim 23, wherein the transaction information comprises the merchant name, merchant type, merchandise category, merchant city, and merchant state of each transaction against the financial account.

28. The method of claim 25, further comprising:
using the transaction information to determine a purchasing behavior of the cardholder, wherein the incentives are related to the purchasing behavior.

29. A system managing a financial account of a cardholder, the system comprising:
a component for defining one or more attributes associated with the financial account, the one or more attributes comprising information on one or more for a billing statement for the financial account;
a component for sending the cardholder the billing statement, wherein the billing statement includes one or more for one or more children related to the cardholder depending on the one or more attributes of the financial account.

30. The system of claim 29, further comprising:
a component for creating the financial account for the cardholder.

31. The system of claim 29, further comprising:
a component for identifying an existing cardholder associated with the financial account;
a component for determining whether the existing cardholder wants to receive one or more incentives with the billing statement.

32. The system of claim 29, wherein the determining whether the existing cardholder wants to receive the billing statement further comprises:
a component for sending the existing cardholder a questionnaire to indicate whether the cardholder wants to receive one or more incentives with the billing statement.

33. The system of claim 29, further comprising:
a component for gathering information about the cardholder, wherein the information comprises information regarding the children, and transaction information; and
a component for determining a format of each incentive based on the gathered information.

34. The system of claim 31, wherein the format is at least one of a sticker, a toy, a press-on tattoo, and a coupon.

35. The system of claim 31, wherein the transaction information comprises the merchant name, merchant type, merchandise category, merchant city, and merchant state of each transaction against the financial account.

36. The system of claim 33, further comprising:
a component for using the transaction information to determine a purchasing behavior of the cardholder, wherein the one more incentives is related to the purchasing behavior.

37. The system of claim 29, further comprising:
a component for informing the cardholder that the one or more incentives will not be included in a next month's billing statement if a payment indicated in the billing statement is received past a payment due date.

38. The system of claim 29, wherein the one or more attributes include information about whether to include the one or more incentives with the billing statement.

39. The system of claim 38, further comprising:
a component for determining whether a payment associated with the financial account has been received; and
a component for changing the one or more attributes based on the determination of whether the payment has been received.

40. The system of claim 38, further comprising:
a component for determining whether the cardholder is in good standing; and
a component for changing the one or more attributes based on the determination of whether the cardholder is in good standing.

41. The system of claim 40, further comprising:
a component for changing the one or more attributes to indicate not to include the one or more incentives for a next month's billing statement based on the determination of whether the cardholder is in good standing.

42. The system of claim 40, wherein the cardholder is in good standing if the cardholder has made at least the minimum payment in the last 30 days.

43. The system of claim 29, wherein the one or more incentives include an incentive for the cardholder to make a timely payment.

44. The system of claim 29, wherein the billing statement is at least one of a paper-based statement and an Internet-based statement.

45. The system of claim 41,.further comprising:
a component for sending the one or more incentives separately if the billing statement is Internet-based.

46. The system of claim 29, further comprising:
a component for allowing the cardholder to select a format and a subject matter of the one or more incentives, wherein the format is at least one of a sticker, a toy, a press-on tattoo, and a coupon.

47. The system of claim 29, wherein the financial account is one of a credit card account or a check card account..

48. The system of claim 38, further comprising:
a component for determining whether the cardholder is an active cardholder; and
a component for changing the one or more attributes based on the determination of whether the customer is an active cardholder.

49. The system of claim 48, wherein determining whether the cardholder is an active cardholder further comprises:
a component for determining whether the cardholder has used the financial account in the past 45 days or has a balance currently on the financial account.

50. A computer-readable medium which stores a set of instructions which when executed performs a method for providing a financial card to at least one recipient for a consumer, the method comprising:
defining one or more attributes associated with the financial account, the one or more attributes comprising information on one or more incentives for a billing statement for the financial account;
sending the cardholder the billing statement, wherein the billing statement includes one or more incentives for one or more children related to the cardholder depending on the one or more attributes of the financial account.
